(19) United States
(12) Patent Application Publication
(10) Pub. No.: US 2014/0129552 A1
(43) Pub. Date: May 8, 2014

(54) LEVERAGING HOMOPHILY IN RANKING SEARCH RESULTS

(71) Applicant: Linkedln Corporation, Mountain View, CA (US)

(72) Inventors: Shakti Dhirendraji Sinha, Sunnyvale, CA (US); Ramesh Dommeti, San Jose, CA (US); Bradley Scott Mauney, Mountain View, CA (US)

(73) Assignee: Linkedln Corporation

(21) Appl. No.: 13/667,756

(22) Filed: Nov. 2, 2012

(51) Int. Cl. G06F 17/30

(52) U.S. Cl. CPC G06F 17/3053
USPC 707/724; 707/732

(57) ABSTRACT

Techniques for ranking search results generated by a search engine are described. Consistent with some embodiments, a search engine processes a search query to identify member profiles of members of a social network service for presentation in a search results page or user interface. The member profiles are presented in the search results ordered based on a ranking score that is derived at least in part by identifying similarities in the member profile attributes of the member profiles satisfying the search query and the member profile of the person performing the search. Accordingly, to the extent that a member profile has similarities shared in common with the member profile of the member performing the search, that member profile is more likely to be presented more prominently in the search results.

### TECHNICAL FIELD

The present disclosure generally relates to data processing systems and information search engines. More specifically, the present disclosure relates to methods, systems and computer program products for ranking and presenting search results with a search engine.

### BACKGROUND

Online social network services provide users with a mechanism for defining, and memorializing in a digital format, their relationships with other people and other entities (e.g., companies, schools, etc.). This digital representation of real-world relationships and associations is frequently referred to as a social graph. There are a variety of web-based applications and services that implement and maintain their own social graph, and still more applications and/or services that leverage the social graph of a third-party social network service (e.g., via publically available application programming interfaces, or APIs). The number and variety of applications and services that leverage a social graph maintained by a social network service is seemingly endless. For instance, a variety of messaging and content sharing applications leverage a social graph to establish user privileges for sharing content with, or accessing the content of, others.

In addition to maintaining a social graph, many social network services maintain a variety of personal information about their members. For instance, with many social network services, when a user registers to become a member and/or at various times subsequent to registering, the member is prompted to provide a variety of personal or biographical information, which may be displayed in a member's personal web page. Such information is commonly referred to as personal profile information, or simply “profile information,” and when shown collectively, it is commonly referred to as a member's profile. For instance, with some of the many social network services in use today, the personal information that is commonly requested and displayed as part of a member's profile includes a person's age, birthdate, gender, interests, contact information, residential address, home town and/or state, the name of the person's spouse and/or family members, and so forth. With certain social network services, such as some business or professional network services, a member's personal information may include information commonly included in a professional resume or curriculum vitae, such as information about a person's education, the schools, colleges or universities that the member attended, the company at which a person is employed, an industry in which a person is employed, a job title or function, an employment history, skills possessed by a person, professional organizations of which a person is a member, and so on.

Because social network services are a rich source of information about people and their relationships with other people, social network services are an extremely useful tool for performing certain tasks. For example, just as a telephone directory, phone book, or white pages previously served as the go-to source for basic information about people, contemporary social network services serve as a far richer directory of people. Many people use social network services to search for member profiles of friends, colleagues, classmates, and other people they may know, or want to know. Accordingly, many social network services provide a search engine to facilitate searching for the member profiles of members of the social network service. However, because social network services have so many members, finding the correct member profile is often difficult, particularly when searching with a search query that is a common name shared by many members.

### DESCRIPTION OF THE DRAWINGS

Some embodiments are illustrated by way of example and not limitation in the FIG.s of the accompanying drawings, in which:

FIG. 1 is a block diagram of the functional modules or components that comprise a computer-network based social network service, including a search engine consistent with some embodiments of the invention;

FIG. 2 is a functional block diagram of a search engine, consistent with some embodiments of the invention:

FIG. 3 is a flow diagram illustrating the method operations that occur when processing a search query, consistent with some embodiments of the invention;

FIG. 4 is a user interface diagram illustrating an example of how search results may be presented by a search engine, consistent with some embodiments of the invention; and

FIG. 5 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for processing a search query to identify member profiles of members of a social network service for presentation in a search results page or other user interface. The member profiles, which represent the search results, are presented positioned (e.g., ordered) based on a ranking score that is assigned to each search result and derived at least in part based on identifying similarities in the member profiles of the members representing the search results and the member profile of the member performing the search. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

Homophily is the tendency of people to associate and/or bond with similar others. In the context of a web-based social network service, homophily may be exhibited when members of the social network service having similar member profile attributes and characteristics memorialize their relationship, affiliation, or association with one another, for example, by connecting with one another, or by one member following another, and so forth. Similarly, when a member performs a search for another member, for example, by submitting a first and/or last name as a search query, the concept of homophily may be observed when the searching member selects from the search results a member profile of another member having a fair degree of overlap (e.g., member profile attributes shared in common) with the searching member.

Consistent with embodiments of the present invention, the historical information that results from the processing of search queries is maintained so that it can be analyzed to identify various member profile attributes for which there is a high degree of correlation between a searching member, and a member whose member profile has been selected from a set of search results. For example, for a particular search query specified as a first and last name that has been submitted by a searching member, a tracking module will store the set of member profiles shown in the search results, as well as the particular member profile that the searching member has selected from the search results. Upon aggregating this historical information for a sufficiently large number of processed search queries, data analysis is performed to identify the member profile attributes or characteristics that are most frequently shared in common by members performing searches, and the members whose member profiles have been selected from the sets of search results.

As described in greater detail below, subsequent to identifying the member profile attributes that are most frequently shared in common by searching members and members whose member profiles are selected from the search results, one or more of these member profile attributes or characteristics are used by a search engine in an algorithm for deriving a ranking score or search relevance score for use in the ranking or ordering of search results presented in a search results page (or similar user interface). Consequently, when a user performs a particular type of search query, the search results are presented in order of a ranking score that is assigned to each search result, where the ranking score is derived at least in part based on an analysis of similarities in certain member profile attributes or characteristics of the member profiles of the members whose member profiles constitute the search results and the member profile of the member performing the search. This causes the most relevant search results (i.e., member profiles) to be presented in the most prominent positions within the search results page or user interface. Consequently, if several members of the social network service share the same name, or have a very similar name, the existence of similarities in the member profiles of certain members and the member performing the search can be used to present the most relevant member profiles. Other advantages and aspects of the present inventive subject matter will be readily apparent from the description of the figures that follows.

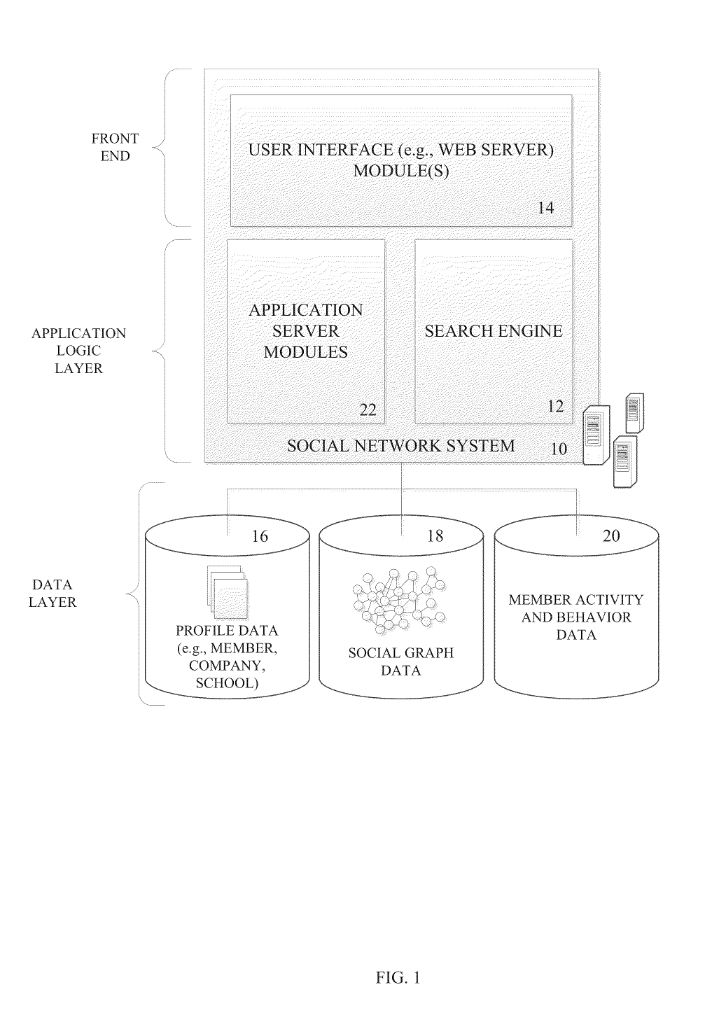

FIG. 1 is a block diagram of the functional modules or components that comprise a computer- or network-based social network service 10, including a search engine 12 consistent with some embodiments of the invention. As shown in FIG. 1, the social network system 10 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end consists of a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the social network service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the social network service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generates various user interfaces (e.g., web pages) with data retrieved from various data sources in the data layer. With some embodiments, individual application server modules 22 are used to implement the functionality associated with various applications, services and features of the social network service. For instance, a messaging application, such as an email application, an instant messaging application, or some hybrid or variation of the two, may be implemented with one or more application server modules 22. Of course, other applications or services may be separately embodied in their own application server modules 22.

The social network service may provide a broad range of applications and services that allow members the opportunity to share and receive information, often customized to the interests of the member. For example, with some embodiments, the social network service may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in a database (not shown). When a member joins a group, his or her membership in the group will be reflected in the social graph data stored in the database with reference number 18. With some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database with reference number 18.

In addition to the various application server modules 22, the application logic layer includes a search engine 12. As illustrated in FIG. 1, with some embodiments the search engine 12 is implemented as a service that operates in conjunction with various application server modules 22. For instance, any number of individual application server modules 22 can invoke the functionality of the search engine 12. However, with various alternative embodiments, the search engine 12 may be implemented as its own application server module such that it operates as a stand-alone application. With some embodiments, the search engine 12 may include or have an associated publicly available application programming interface (API) that enables third-party applications to invoke the functionality of the search engine 12. With some embodiments, the search engine 12 may be a people-search engine, and provide functionality to search for people (e.g., member profiles) specifically. Alternatively, the search engine module 12 may facilitate searching for any type of information entity (e.g., people or member profiles, companies, schools and other educational institutions, etc.) that is maintained and used by the various applications of the social network system, such as companies, groups, job listings, etc. With such an embodiment, the user performing the search may specify the type of entity to be searched for. Alternatively, the search engine may algorithmically identify the type of search being performed, for example, based on the search query.

As described in greater detail below, in general, the search engine 12 uses a ranking algorithm that leverages the concept of homophily, for example, by boosting or increasing the ranking scores assigned to certain of the member profiles satisfying the search query when those member profiles share one or more particular attributes or characteristics in common with the member profile of the member performing the search. For example, with some embodiments, the ranking algorithm will increase the ranking score assigned to those member profiles satisfying the search query and having a profile attribute indicating the member is employed at the same company as the member performing the search. Accordingly, if the member profile of the member performing the search indicates that the member is currently employed at ACME Products, any member profile that satisfies the search query and also indicates that the member is employed at the same company—that is, ACME Products—will have its ranking score adjusted upward or otherwise calculated or derived to reflect this shared member profile attribute. Accordingly, with all else equal, if two member profiles for two different persons with the same name, (e.g., John Doe) differ in that one of the members is employed at the same company as the member performing the search, and the other member is employed at some other company, the member profile of the member employed at the same company as the searching member will be assigned the higher ranking score, and thus be presented more prominently in a list of search results.

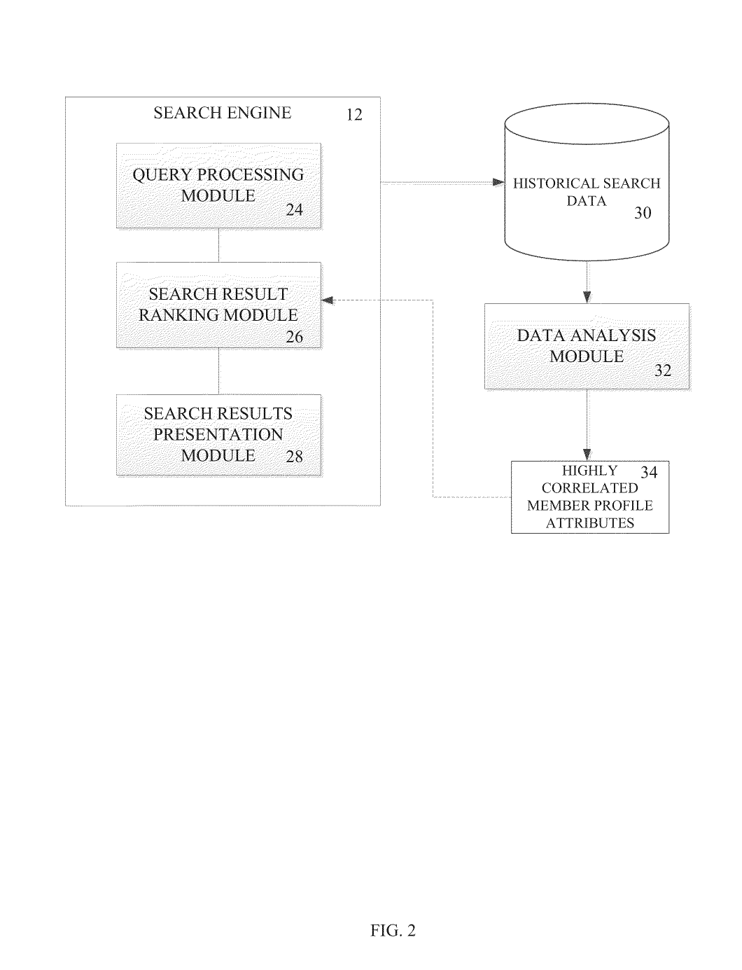

FIG. 2 is a functional block diagram of a search engine, consistent with embodiments of the invention. As illustrated in FIG. 2, the search engine 12 includes a query processing module 24, a search results ranking module 26 and a search results presentation module 28. In general, the query processing module 24 receives a search query and then processes the search query by selecting or otherwise identifying data in a database (e.g., a searchable index) that satisfies the search query. Depending upon the nature of the search query, one of several matching rules may be evaluated to identify the member profiles that match the query. For example, if the search query is a first and last name, the search query is processed by selecting the relevant records from a database having names in the appropriate database field that match, exactly or partially, the name specified in the search query. If the search query specifies some other member profile attribute, in addition to or instead of a first and/or last name, a particular matching rule for that member profile attribute may be evaluated to identify member profiles that satisfy the query. For instance, the search query may be a first and/or last name. Alternatively, in some instances, the search may specify one or more other member profile attributes, to the exclusion, or in addition to, a name. For instance, a search query may include any combination of the following member profile attributes: name (first and/or last); geographical information, including country, state, city, postal code, including proximity to any of the aforementioned; job title; company of current or previous employment; school attended; industry of employment; groups of which one is a member; languages spoken; job function; company size; skills possessed; relationship to person initiation the search (e.g., first degree connection, second degree, and so forth); interests; experience or seniority level; as well as many others. The query processing module 24, using the received search query, identifies a set of member profiles satisfying the search query.

The search results ranking module 26 derives for each search result (e.g., member profile) a ranking score representing a measure of relevance, particularly, in view of both the search query and the particular member who has invoked or initiated the search. With some embodiments, the ranking algorithm may utilize any number of input signals for use in deriving a ranking score, where one or more signals are combined in some way (e.g., multiplied or added together) to derive an overall ranking score. Consistent with embodiments of the invention, at least one of those input signals or component scores represents the extent to which certain member profile attributes are shared in common between a member profile in the search results and the member profile of the member who has initiated or invoked the search. Accordingly, when the query processing module identifies or selects the database records representing the member profiles that satisfy the search query, certain member profile attributes may also be retrieved for the purpose of comparing those member profile attributes with the corresponding member profile attributes of the member who has initiated or invoked the search. Depending upon the particular member profile attributes in consideration, a particular matching rule may be evaluated to determine the extent to which two members have similarity with respect to the particular member profile attribute.

With some embodiments, the ranking module 26 may have multiple ranking algorithms for use in generating ranking scores. Accordingly, a particular ranking algorithm may be selected and used depending upon the type of search query that has been received, or the specific member profile attributes that have been specified as part of the search query. For instance, if the search query is determined to be a simple name search (e.g., first and/or last name), a particular ranking algorithm for use with that type of search query might be selected and used to derive and assign ranking scores to the search results. However, if the search query specifies a particular member profile attribute, then a different ranking algorithm may be selected and used in deriving and assigning ranking scores. In general, a ranking algorithm used by the ranking module may include any number of weighting factors, which may vary depending upon the search query type, and the specific member profile attribute types that have been specified as part of the search query. The following example is illustrative.

Presume for sake of an example that a member of the social network service residing in Detroit, Mich. desires to reach out and make contact with a former college classmate known to now reside in Seattle, Wash. The searching member generates a search query specifying both the first and last name of the college classmate and specifies as a search parameter the location, “Seattle, Wash.” Because the search query specifically indicates a geographical location that is different from the searcher's geographical location, the ranking algorithm selected for use in deriving ranking scores for the search results should not promote or otherwise boost the relevance scores assigned to member profiles as a result of those member profiles indicating that a member lives in the same location (i.e., Detroit, Mich.) as the member performing the search. Furthermore, presume for a moment that the member residing in Detroit attended college in Seattle, Wash. Because the query has specified the geographical location, Seattle, Wash., and because the searching member attended college in Seattle, Wash., those member profiles matching the query and specifying attendance or graduation from the same college as the searching member may be boosted in the search results ranking. For instance, the ranking module may weight more heavily any member profile in which the member has indicated attendance at, or graduation from, the same university as the searching member. In essence, by specifying a particular member profile attribute (in this example, a geographical location), another member profile attribute (e.g., college/university attended) is weighted more heavily in the ranking algorithm to reflect the presumed importance of a member profile that has as an attribute a college or university that is the same as the member performing the search.

Once the search result ranking module 26 has generated and assigned to each search result a ranking score, the search results presentation module 28 causes the search results to be presented, arranged in order of their assigned ranking score, in a user interface. For instance, the user interface may be a search results page providing a simple list of at least a portion of the member profiles that satisfied the query. Alternatively, in some instances, the user interface may operate in conjunction with the query processing module 24 and the search results ranking module 26 to implement an incremental search technique whereby search results are presented while a member is typing in the search query. Such results may be presented, for example, in a drop down suggestion list, or directly in a portion of a search results web page.

As illustrated in FIG. 2, with some embodiments, for each search query that is processed by the search engine, the search engine 12 will store resulting data—in particular, the search results that resulted from a particular search query, and any user-selections—in a database 30. Once a sufficiently large data set for a particular period of time has been established, a data analysis module 32 is then used to identify the specific member profile attributes that are most highly correlated amongst the member profiles that are ultimately selected from a search results set, and the member profile of the member who has invoked a particular search. In this manner, the most highly correlated member profile attributes 34 are identified, and can be used in a ranking algorithm by the search results ranking module 26. With some embodiments, the ranking algorithm may be implemented to weight the various member profile attributes used in the ranking algorithm based on the level of correlation as determined by the data analysis module 32. For example, if the data shows that a searching member selects a member profile from the search results having a first member profile attribute (e.g., geographic location of residence) in common with his or her own member profile a particular percentage (e.g., seventy-five percent) of the time, and a second member profile attribute (e.g., the company at which the member is employed) in common with the searching member's profile some percentage of time lower than seventy-five, this information may be used to weight the significance of the two member profile attributes contribution to the overall ranking score. In any case, the data analysis module 32 is used to analyze historical search data 30 for the purpose of identifying the member profile attributes that are the best input signals for the ranking algorithm.

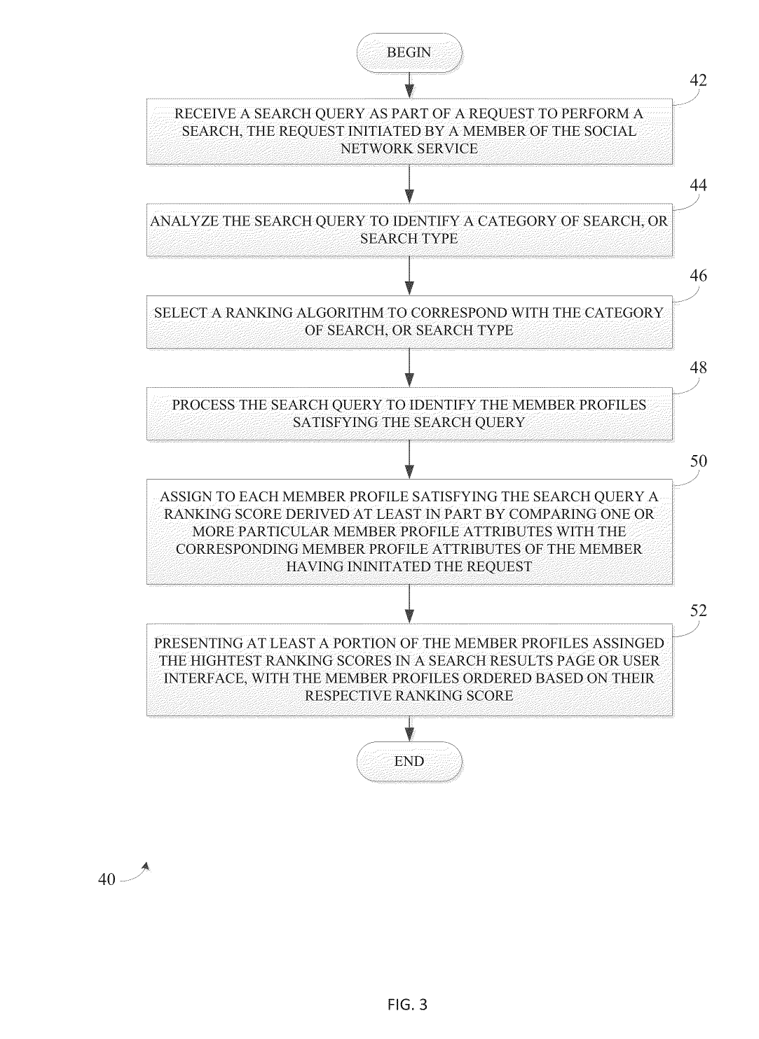

FIG. 3 is a flow diagram illustrating the method operations 40 that occur when processing a search query, consistent with some embodiments of the invention. At method operation 42, the search engine receives a search query from a member of the social network service. With some embodiments, at method operation 44, the search engine will analyze the search query to identify a particular category of search that is being requested, or to otherwise classify the search query by a particular search type. For example, with some embodiments, based on historical search data, certain search queries may be grouped into different categories based on the type of search result that a searching member selects. For instance, if the historical search data indicates that the vast majority of members select the company page for the company, Widgets Inc., after submitting a search request with the search query, “Widgets,” the search query may be classified as a company search query. Similarly, for particular combinations of first and last names, the search engine may classify the search type as a member profile search. In some instances, a search query may be classified as a celebrity search. Consequently, as set forth below, the particular ranking algorithm that is used to derive ranking scores for the search results can be tailored to the category or type of search query being processed.

At method operation 46, a ranking algorithm is selected based on the type of search that has been requested. For example, with some embodiments, the type of search may be determined algorithmically based on the search query. Alternatively, with some embodiments, the searching member may expressly identify the type of search being performed, and in particular, specify that the search is for a member. In any case, at method operation 48, the search query is processed to identify the member profiles satisfying the search query. If the search type is unknown, other searchable entities (e.g., companies, educational institutions, groups, web pages, or others) may also be identified. At method operation 50, the search engine assigns to each member profile that satisfies the search query a ranking score. The ranking score may be derived based on a variety of input signals, including at least one signal or component score representing a measure of the similarity of certain member profile attributes. Specifically, the ranking score may be increased for a particular member profile when one or more member profile attributes of the particular member profile have the same, or a similar, value as the corresponding member profile attribute for the member profile of the member who has invoked or initiated the search request.

The particular member profile attribute or attributes that are compared may vary considerably from one embodiment to the next, but may include any one or more of: geographical information, including country, state, city, postal code, including proximity to any of the aforementioned; job title; company of current or previous employment; school attended; industry of employment; groups of which one is a member, languages spoken; job function; company size; skills possessed; relationship to person initiating the search (e.g., first degree connection, second degree, and so forth); interests; and/or, experience or seniority level. With some embodiments, the comparison of member profile attributes involves matching algorithms beyond identifying exact matches. For example, depending on the particular member profile attribute being evaluated or compared, a different matching algorithm or matching requirement may be specified, such that the term “match,” as used herein, includes both exact matches as well as partial matches. With some member profile attributes, such as the geographical location of a member, the matching algorithm or requirement may specify a range, such that a match exists when the distance between two geographical locations is within a particular threshold, or more generally, when some value is within a certain range.

Finally, after a ranking score has been assigned to each search result (e.g., member profile satisfying the search query), the search results are presented at method operation 52, arranged in order of their respective ranking scores. With some embodiments, the search results may appear in an infinitely scrolling web page. Alternatively, with some embodiments, a portion of the search results having the highest assigned ranking score may be presented on a first page of the search results, with subsequent pages showing additional results. In general, the search results are shown in a list, with the member profile having the highest assigned ranking score appearing at the top of the list. However, in various alternative embodiments, the search results may be presented in an alternative layout. For example, with a mobile or tablet device, the search results may appear in a list that is navigated from side-to-side, as opposed to top-to-bottom.

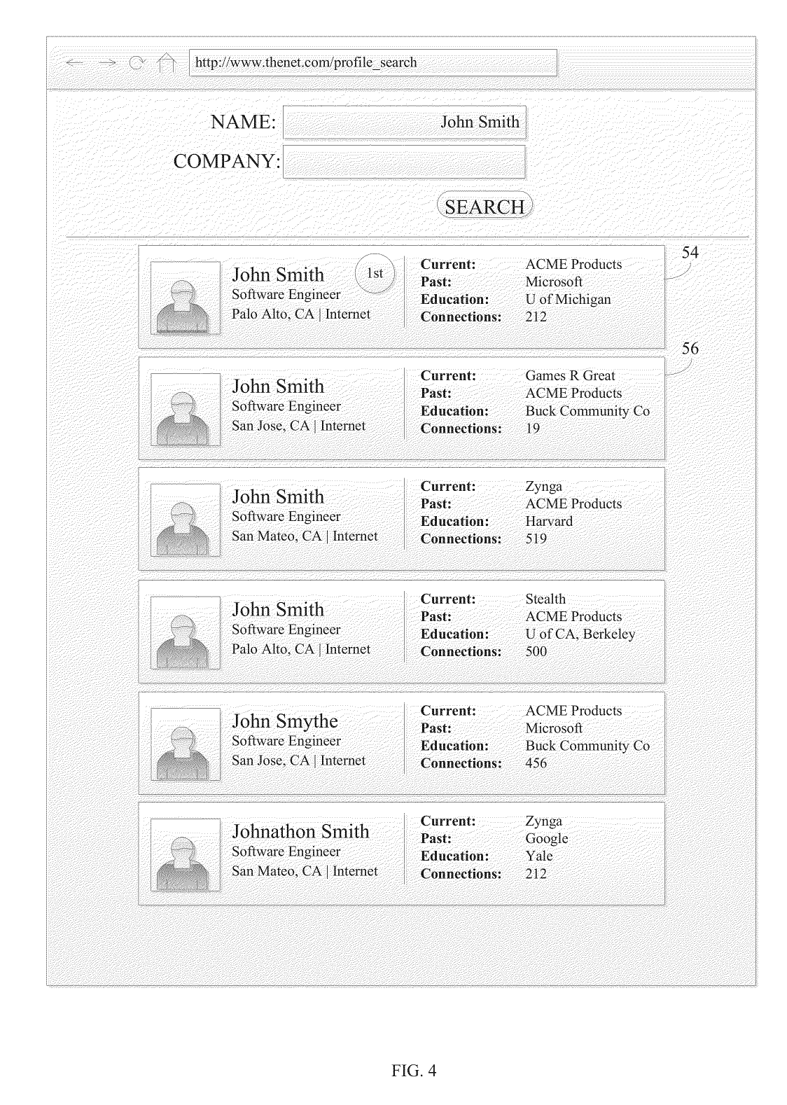

FIG. 4 is a user interface diagram illustrating an example of how search results may be presented by a search engine, consistent with some embodiments of the invention. In the example user interface of FIG. 4, a member of a social network service has performed a search with the search query, “John Smith”. The results of processing the search query are shown in the example web page, with six different member profiles satisfying the search query. For purposes of this example, presume that the searching member resides in San Jose, Calif., and is currently employed at “Games R Great.” The member profile presented in the search results with reference number 54 appears at the top of the search results list, because it has been assigned the highest ranking score, in part because the member associated with the member profile is a direct or first degree connection, of the searching member. The second search result in the list, with the second highest assigned ranking score, is the member who both lives in San Jose—the same city in which the searching member resides—and is employed at the company “Games R Great”—the same company at which the searching member is employed. In this example, the ranking score assigned to the member profile with reference number 56 was given a boost as a result of similarities in specific member profile attributes shared in common with the member initiating the search.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

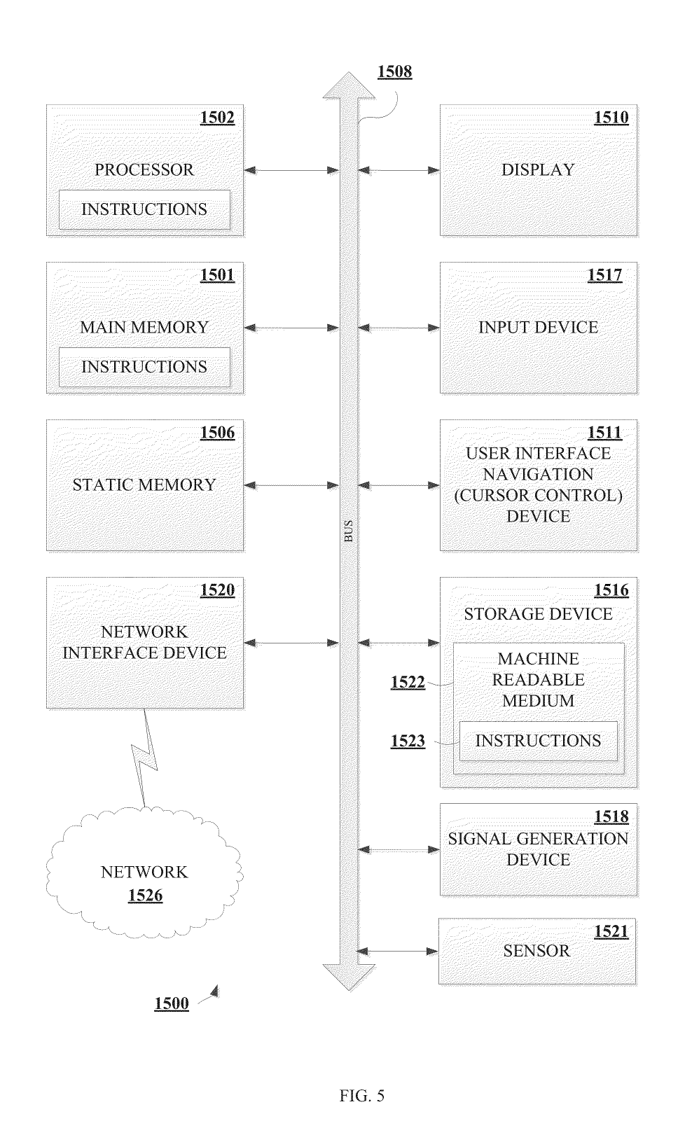

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
processing a search query initiated by a member of a social network service to identify a set of members of the social network service having member profiles satisfying the search query;
assigning to each member profile of a member in the set of members having member profiles satisfying the search query a ranking score derived in part by comparing at least one member profile attribute of the member profile with a corresponding member profile attribute of the member profile of the member having initiated the search query;
presenting as search results in a search results interface a portion of each member profile of a member in the set of members having member profiles satisfying the search query, the search results positioned based on the ranking score assigned to each member profile.

2. The method of claim 1, wherein the set of members of the social network service having member profiles satisfying the search query are those members having a member profile indicating a name that matches the search query.

3. The computer-implemented method of claim 1, wherein the at least one member profile attribute is an attribute specifying any one of: a geographical region of residence or employment, including any one or combination of a city, metropolitan area, state, or country; an industry in which a member is employed; a school attended by a member; a company at which a member is, or was previously, employed; an age of a member; memberships in self-organized or externally defined groups; skills possessed by members; or explicitly or implicitly specified interests or affiliations.

4. The computer-implemented method of claim 3, further comprising:
increasing the ranking score for a particular member profile with a weighting factor when the at least one member profile attribute of the particular member profile and the corresponding member profile attribute of the member profile of the member having initiated the search query match.

5. The computer-implemented method of claim 4, wherein the respective member profile attributes match when a matching rule for the member profile attribute is satisfied.

6. The computer-implemented method of claim 4, wherein the weighting factor by which the ranking score is increased is dependent upon the member profile attributes that match.

7. The computer-implemented method of claim 3, wherein the ranking score is derived by combining a plurality of component scores, one of which is based on a result of said comparing at least one member profile attribute of the member profile with a corresponding member profile attribute of the member profile of the member having initiated the search query.

8. The computer-implemented method of claim 1, further comprising:
analyzing the search query to determine that the search query is of a particular type; and
based on the type of the search query, selecting a ranking algorithm for use in deriving the ranking score to be assigned to each member profile satisfying the search query.

9. The computer-implemented method of claim 1, further comprising:
detecting a selection of a member profile from the search results; and
storing the search results along with information identifying the selected member profile.

10. The computer-implemented method of claim 9, further comprising:
analyzing data representing previously processed search results to identify the frequency with which one or more member profile attributes are shared in common between a member whose member profile has been selected from a set of search results, and a member who has initiated a search.

11. A computer-readable storage medium storing instructions thereon, which, when executed by a processor of a server computer, cause the server computer to:
process a search query initiated by a member of a social network service to identify a set of members of the social network service having member profiles satisfying the search query;
assign to each member profile of a member in the set of members having member profiles satisfying the search query a ranking score derived in part by comparing at least one member profile attribute of the member profile with a corresponding member profile attribute of the member profile of the member having initiated the search query;
present as search results in a search results interface a portion of each member profile of a member in the set of members having member profiles satisfying the search query, the search results positioned based on the ranking score assigned to each member profile.

12. The computer-readable storage medium of claim 11, wherein the set of members of the social network service having member profiles satisfying the search query are those members having a member profile indicating a name that matches the search query.

13. The computer-readable storage medium of claim 11, wherein the at least one member profile attribute is an attribute specifying any one of: a geographical region of residence or employment, including any one or combination of a city, metropolitan area, state, or country; an industry in which a member is employed; a school attended by a member; a company at which a member is, or was previously, employed; or, an age of a member; memberships in self-organized or externally defined groups; skills possessed by members; or explicitly or implicitly specified interests or affiliations.

14. The computer-readable storage medium of claim 13, including further instructions, which, when executed by the processor of the server computer, cause the server computer to:
increase the ranking score for a particular member profile with a weighting factor when the at least one member profile attribute of the particular member profile and the corresponding member profile attribute of the member profile of the member having initiated the search query match.

15. The computer-readable storage medium of claim 14, wherein the respective member profile attributes match when a matching requirement for the member profile attribute is satisfied.

16. The computer-readable storage medium of claim 14, wherein the weighting factor by which the ranking score is increased is dependent upon the member profile attributes that match.

17. The computer-readable storage medium of claim 13, wherein the ranking score is derived by combining a plurality of component scores, one of which is based on a result of said comparing at least one member profile attribute of the member profile with a corresponding member profile attribute of the member profile of the member having initiated the search query.

18. The computer-readable storage medium of claim 11, including further instructions, which, when executed by the processor of the server computer, cause the server computer to:
analyze the search query to determine that the search query is of a particular type; and
based on the type of the search query, select a ranking algorithm for use in deriving the ranking score to be assigned to each member profile satisfying the search query.

19. The computer-readable storage medium of claim 1, including further instructions, which, when executed by the processor of the server computer, cause the server computer to:
detect a selection of a member profile from the search results; and
store the search results along with information identifying the selected member profile.

20. The computer-readable storage medium of claim 19 including further instructions, which, when executed by the processor of the server computer, cause the server computer to:
analyze data representing previously processed search results to identify the frequency with which one or more member profile attributes are shared in common between a member whose member profile has been selected from a set of search results, and a member who has initiated a search.
